(19) United States
(12) Patent Application Publication
(10) Pub. No.: US 2017/0291768 A1
(43) Pub. Date: Oct. 12, 2017

(54) INSULATED PICK LINE ASSEMBLY FOR REFRIGERATED GOODS

(71) Applicant: Personal Trainer Foods, LLC, Fort Worth, TX (US)

(72) Inventor: Michael Paul Starks, Fort Worth, TX (US)

(21) Appl. No.: 15/093,112

(22) Filed: Apr. 7, 2016

(51) Int. Cl. B65G 1/137; B65G 1/02

(52) U.S. Cl. CPC B65G 1/1376; B65G 1/023

(57) ABSTRACT

Provided are an insulated pick line assembly system for refrigerated goods and corresponding method of manufacturing the same. The pick line assembly system may include a refrigerated area having a plurality of bins. Each bin may be configured to receive at least one product for picking. The pick line assembly system may include an insulated assembly area separated from the refrigerated area by a barrier. The insulated assembly area may be configured to be warmer than the refrigerated area. The barrier of the pick line assembly system may define at least one opening, such that the refrigerated area may be connected to the insulated assembly area via the at least one opening. A plurality of bins may be disposed adjacent the barrier, such that each bin may be accessible from the insulated assembly area via the at least one opening.

### FIELD OF THE INVENTION

Embodiments of the present invention generally relate to pick lines and, more particularly, to systems and methods for assembling packages of refrigerated goods.

### BACKGROUND OF THE INVENTION

Refrigerated goods, such as frozen foods, pre-made meals, perishable items, or other similar products, may require specialized shipping and packaging facilities to avoid spoilage before the goods reach the end customer. Prior to preparing packages for shipping, particularly packages including perishable goods, the goods must be stored in cool or freezing temperatures. Traditional packaging systems and methods require the packages of goods to be assembled in the refrigerated area to avoid spoilage.

### BRIEF SUMMARY OF THE INVENTION

Provided herein are a pick line assembly system and associated apparatus and methods. In some embodiments, an insulated pick line assembly system for refrigerated goods may be provided. The pick line assembly system may include a refrigerated area comprising a plurality of bins. Each bin may be configured to receive at least one product for picking. The pick line assembly system may include an insulated assembly area separated from the refrigerated area by a barrier. The insulated assembly area may be configured to be warmer than the refrigerated area. The barrier may define at least one opening, such that the refrigerated area may be connected to the insulated assembly area via the at least one opening. The plurality of bins may be disposed adjacent the barrier, such that each bin may be accessible from the insulated assembly area via the at least one opening.

In some embodiments, the barrier may define at least one wall and at least one ceiling, and the insulated assembly area may be disposed at least partially below the at least one ceiling. In some embodiments, the barrier may be disposed within a refrigerated warehouse.

The at least one opening may include a plurality of openings. Each bin may be disposed adjacent to at least one of the plurality of openings.

In some embodiments, the plurality of openings may include a first zone comprising a first plurality of openings and may include a second zone comprising a second plurality of openings. Each opening of the first plurality of openings may be closer to at least one other opening of the first plurality of openings than to any opening of the second plurality of openings. In some embodiments, the pick line assembly system may further include a code scanner proximate at least one of the first zone or the second zone. At least two of the plurality of openings may be spaced vertically from each other. At least two of the plurality of openings may be spaced horizontally from each other.

In some embodiments, the pick line assembly system may include a cover configured to substantially close at least one of the plurality of openings. The cover may be movably attached to the barrier. The cover may be removably positioned in the at least one of the plurality of openings.

In some embodiments, the pick line assembly system may include an order picking apparatus disposed adjacent each bin. The pick line assembly system may include a roller assembly adjacent the barrier in the insulated assembly are. The roller assembly may define a longitudinal direction disposed parallel to the barrier.

In some embodiments, the insulated assembly area may define at least one terminal end terminating at a side wall and at least one open end. The barrier may extend between the at least one terminal end and the at least one open end. The pick line assembly system may further include an inclined roller assembly in the insulated assembly area. The inclined roller assembly may decline from the open end to the terminal end, such that the inclined roller assembly may be configured to deliver boxes to the at least one terminal end.

In another embodiment, a method for manufacturing a pick line assembly system may be provided. The method may include installing a barrier separating a refrigerated area from an insulated area. The refrigerated area may include a plurality of bins, and each bin may be configured to receive at least one product for picking. The insulated assembly area may be configured to be warmer than the refrigerated area. The barrier may define at least one opening, such that the refrigerated area may be accessible from the insulated assembly area via the at least one opening. In some embodiments, the plurality of bins may be disposed adjacent the barrier, such that each bin may be accessible from the insulated assembly area via the at least one opening.

Some embodiments of installing the barrier may include installing the barrier in a refrigerated warehouse. Some embodiments of the method may further include disposing a cover in or over at least one of the plurality of openings, such that the cover may be configured to substantially close the at least one of the plurality of openings.

The method may further include attaching an order picking apparatus adjacent each bin. Embodiments of the method may include positioning a roller assembly adjacent the barrier in the insulated assembly area. The roller assembly may define a longitudinal direction disposed parallel to the barrier.

In some embodiments, the insulated assembly area may define at least one terminal end terminating at a side wall and at least one open end. In some embodiments, the barrier may extend between the at least one terminal end and the at least one open end. The method may further include positioning an inclined roller assembly in the insulated assembly area, and the inclined roller assembly may decline from the open end to the terminal end, such that the inclined roller assembly may be configured to deliver boxes to the at least one terminal end.

### BRIEF DESCRIPTION OF THE DRAWINGS

Having thus described the invention in general terms, reference will now be made to the accompanying drawings, which are not necessarily drawn to scale, and wherein:

FIG. 1 shows a cross-sectional view of a pick line assembly system according to some embodiments discussed herein;

FIG. 2 shows a front view of a plurality of openings and picking indicators in the packaging area of the pick line assembly system shown in FIG. 1;

FIG. 3 shows a perspective view of the packaging area of the pick line assembly system shown in FIG. 1;

FIG. 4 shows a cross-sectional view of a storage area having a packaging area positioned therein according to some embodiments discussed herein; and

FIG. 5 shows a rear view of a plurality of products in the storage area shown in FIG. 4.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

As used herein, the term “packages,” “containers,” “boxes,” “pallets,” and similar terms may be used interchangeably to refer to receptacles capable of receiving one or more products for storage, holding, or transportation.

As used herein, the term “order” refers to product purchases made by a customer, reseller, distributor, or the like (collectively “customer”), which may be fulfilled by assembling and transporting a package of products to the customer. A package may, for example, include portions of an order (e.g., some, but not all, products listed on an order, such as for large orders), a single order (e.g., all products listed on an order), or multiple orders (e.g., products listed on multiple orders for shipment to the same location or customer).

Traditional systems and methods for packing and shipping refrigerated goods are often inefficient and expensive as workers must fill the packages in bulky, heavy clothing and may require frequent breaks in warm areas. Similarly, order fulfillment machinery may operate less efficiently in cold (e.g., below freezing) environments. As a result, the order fulfillment process for refrigerated goods may take much longer than the process for filling an order for unrefrigerated goods, and the cost of fulfilling orders is subsequently higher.

Applicant has identified a number of additional deficiencies and problems associated with conventional package assembly systems and other associated systems and methods. Through applied effort, ingenuity, and innovation, many of these identified problems have been solved by developing solutions that are included in embodiments of the present invention, many examples of which are described in detail herein.

Embodiments of a pick line assembly system may facilitate the filling and organization of packages during an order fulfillment process. The order fulfillment process may involve filling packages to be shipped to customers including packaging a predetermined quantity of each of a plurality of products according to an order. A pick line may include one or more work stations (e.g., zones) at which packages may be assembled by picking the constituent products of an order and assembling packages of the picked products. Embodiments of the pick line assembly system may facilitate robust and efficient packaging to ensure that packages are filled quickly and correctly. For example, in some embodiments, a plurality of frozen and/or refrigerated products (e.g., pre-made meals) may be picked from the refrigerated storage area and put into assembled packages for shipping to customers, distributors, and/or resellers.

In some embodiments, the pick line assembly system may include the refrigerated storage area for holding products in one or more bins prior to packaging. In some embodiments, the refrigerated area may also include a bulk storage area for holding pallets, boxes, or the like containing products for storage prior to being placed in the bins. As used herein, the term “refrigerated” implies colder than room temperature (e.g., colder than approximately 70° F.). In some instances, a “refrigerated area” may be sufficiently cold to prevent or limit spoilage of perishable goods, and in some embodiments a “refrigerated area” may be below the freezing temperature of water, depending on the nature of the products being stored. For example, in some embodiments, the refrigerated area may be from 0° F. to 10° F. or any increment, subdivision, or individual temperature therein (e.g., 2° F. to 5° F.; 6° F. to 9° F.; 3° F.; etc.) for frozen foods.

The pick line assembly system may further include an insulated assembly area that is separated from the refrigerated area by a barrier, and the insulated area may be held at a warmer temperature than the refrigerated area. The barrier may include one or more openings connecting the insulated area with the refrigerated area, such that the bins are accessible from the insulated area. Workers and/or automated picking systems may prepare and fill packages in the warmer, insulated area by loading products from one or more of the openings into a respective package. The pick line assembly system may also position the openings and necessary equipment in close, intuitive proximity to one or more workers to minimize travel and organization time. This system may allow packages of temperature-sensitive products to be quickly and efficiently loaded by workers outside of the refrigerated conditions of the storage area, which improves the workers' comfort and efficiency by, for example, reducing bulky clothing, allowing the workers to have longer shifts, and separating the packaging and stocking processes. For example, in some embodiments, the insulated assembly area maybe from 25° F. to 45° F. or any increment, subdivision, or individual temperature therein (e.g., 31° F. to 43° F.; 26° F. to 35° F.; 29° F.; etc.). In some further embodiments, the insulated assembly area may be from 35° F. to 45° F. or any increment, subdivision, or individual temperature therein.

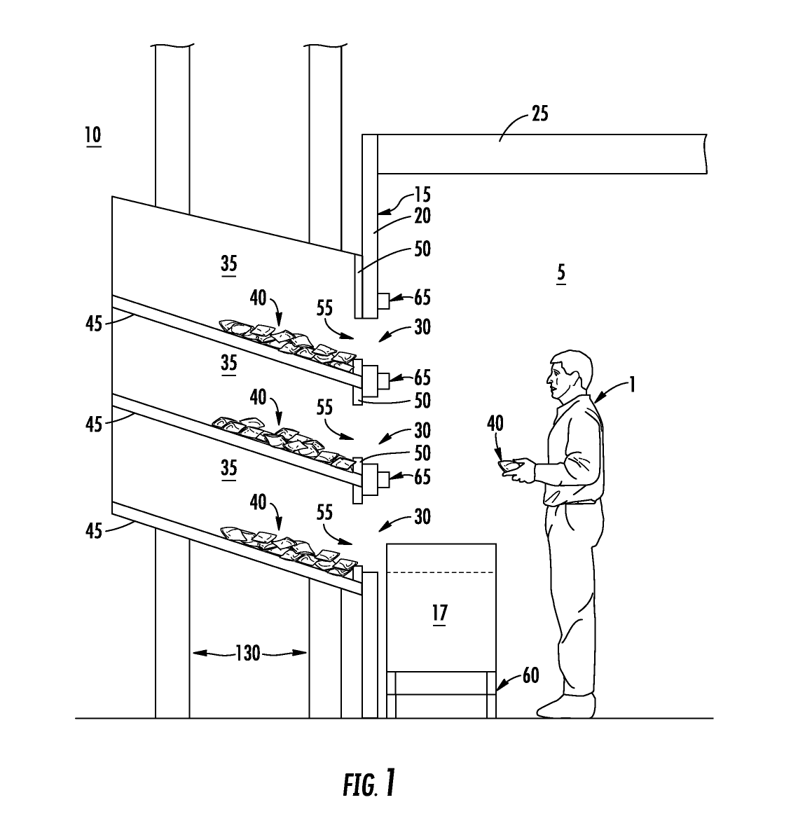

With reference to FIG. 1, a pick line assembly system is shown having a user 1 (e.g., a worker) in an insulated area 5. The insulated area 5 may be adjacent to a refrigerated area 10 and separated from the refrigerated area by a barrier 15, and the user 1 may pack one or more containers 17 (e.g., boxes) of products 40 for shipping. The barrier 15 may include one or more walls 20, ceilings 25, and/or floors to separate the refrigerated area 10 and the insulated area 5.

In some embodiments, the refrigerated area 10 may be a refrigerated warehouse or walk-in refrigerator. The refrigerated area 10 may be cooled with conventional refrigeration technology, as would be appreciated by one of ordinary skill in the art. The insulated area 5 may be heated, either actively or passively, or may include no heating, such that the insulated area is kept warmer than the refrigerated area 10 by being separated and insulated from the refrigerated area. In embodiments using heating, one or more heaters (e.g., central heating units or space heaters) may be fluidly connected with and/or disposed within the insulated area 5. In some embodiments, one or more doors and/or windows may connect the insulated area to an external environment, such that the insulated area may be warmed by the external environment and allow convenient access to the users. In some further embodiments, the insulated area may be connected to a loading dock for transportation of packed containers 17.

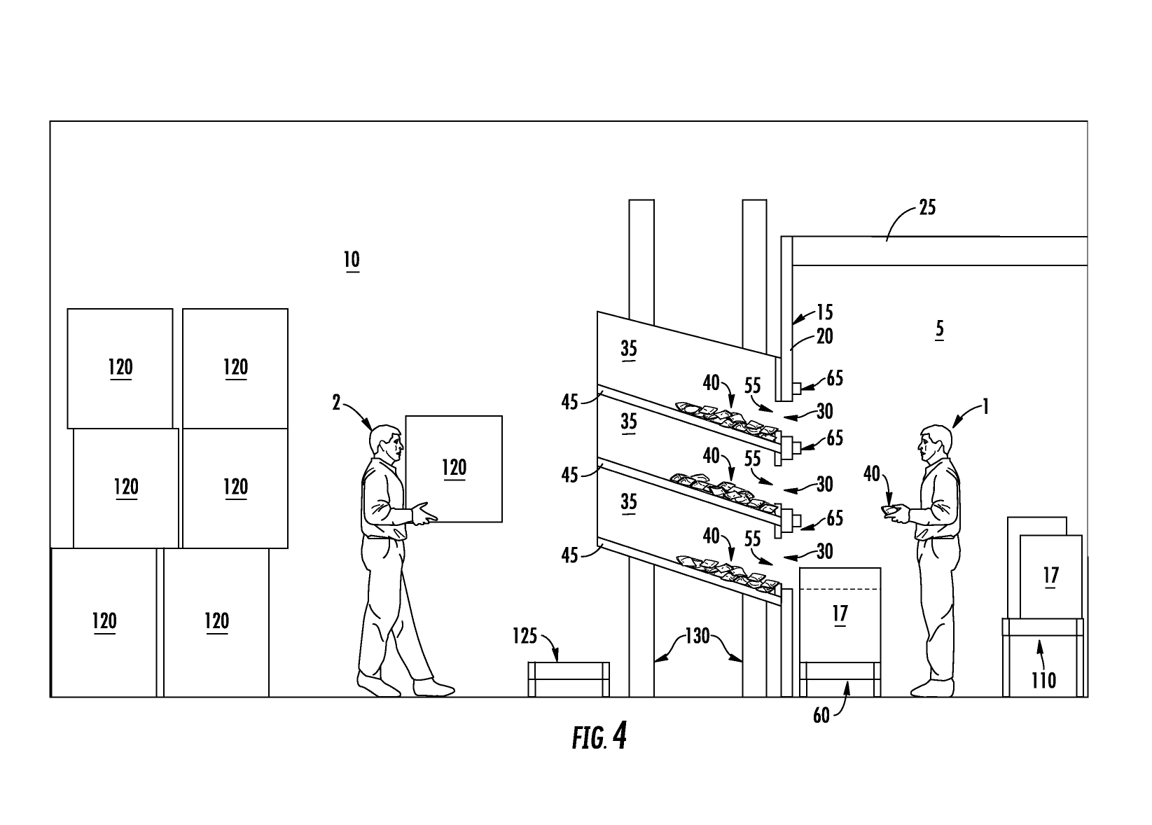

The insulated area 5 may define a tunnel within or adjacent the refrigerated area, such that one or more walls of the barrier 15 separate the refrigerated area 10 from the insulated area. In some embodiments, the insulated area 5 may be a segregated area within the refrigerated area 10 (e.g., as shown in FIG. 4). In such embodiments, the insulated area 5 may be retrofitted into an existing refrigerated area, may be built as a sub-section of the refrigerated area, or may be a mobile packaging area positioned within the refrigerated area. In some alternative embodiments, the insulated area 5 may be adjacent to the refrigerated area 10, such that an outer wall of the refrigerated warehouse or walk-in refrigerator forms the barrier 15.

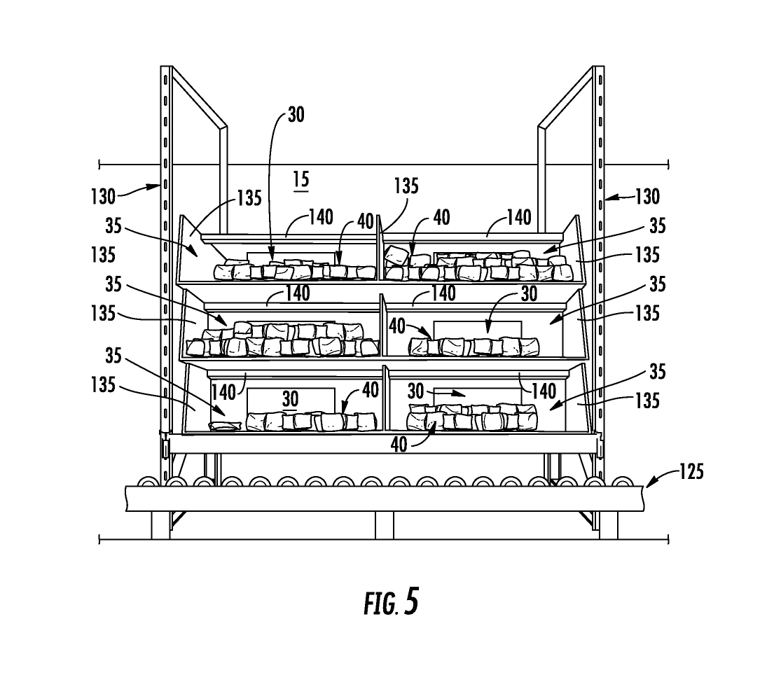

With continued reference to FIG. 1, the refrigerated area 10 may include one or more bins 35 for holding products 40 for packaging. The bins 35 may include segregated storage areas for separating each of a plurality of types of products 40. For example, the bins 35 may include shelves 45 or walls (e.g., as shown in FIG. 5) vertically and/or horizontally separating the bins from one another. The bins may each include a shelf 45 for supporting the products 40, and the shelf may be angled downwardly towards the barrier 15 to encourage the products towards the barrier. In some embodiments, the bins 35 may include one or more front walls 50 adjacent to openings 30 in the barrier 15. The front walls 50 may retain the products (e.g., against the slope of the shelves 45) and, in some embodiments, the front walls may include openings 55 may at least partially align with corresponding openings 30 in the barrier 15. Alternatively, the shelves 45 may terminate at the barrier 15 (e.g., in embodiments in which no front walls 50 are provided.

In some embodiments, the bins 35 may be stationary racks, shelves, containers, stalls or the like, and in some alternative embodiments the bins may be movable storage devices such as pallets, boxes, crates, rolling shelves, or other containers that may, themselves, be movable into and out of position with respect to the barrier 15 for packaging.

In some embodiments, each of the bins 35 may align with one or more openings 30 in the barrier 15 to allow the user 1 to access the products 40 held by the bins from the insulated area 5. In some embodiments, multiple openings 30 may be in communication with a single bin 35 to allow multiple users to access the bin simultaneously and to simplify stocking of the respective bin. In some alternative embodiments, the bins 35 may be configured independently of the opening 30 layout of the barrier 15, such that in some instances, one bin may be adjacent multiple openings or multiple bins may be adjacent one opening. In some embodiments, the size of the bin 35 and/or the number of openings 30 adjacent a particular bin may depend upon the popularity of the product in the bin (e.g., more frequently picked items may have larger bins and/or more access for the users to speed packaging and reduce restocking times). In some embodiments, as discussed below, the position of the bins 35 may also depend upon the respective products' 40 popularity.

The openings 30 may define a cross-sectional area that is larger than a cross section of the largest product 40 in a given bin to allow the product to be passed through a respective opening and removed from the refrigerated area. In some embodiments, as discussed below, the barrier 15 may be made of one or more insulating materials, and the barrier may be adjustable and/or customizable to include openings configured to accommodate the particular assembled package requirements or specific bin configurations. In some embodiments, the openings may define rectangular, square, or rounded cross sections.

In some embodiments, the openings 30 may define a cross-sectional area that is sufficiently small to maintain an ideal temperature in the refrigerated area 10 and the insulated area 5. For example, the openings 30 may define a cross-sectional area that is slightly larger than the cross-section of the largest product and/or the user's hand (e.g., allowing half an inch, one inch, two inches, three inches, etc. of clearance on each side of the product and/or hand). In some embodiments, one or more of the openings 30 may be configured to be continuously open (e.g., at least open during the picking process), such that the refrigeration system coupled with the refrigerated area may overcome the losses from air travelling through the continuously open openings, while also attempting to minimize refrigeration expenses. In such embodiments, the bins 35 may be kept at an ideal temperature for the preservation of the goods (e.g., sub-freezing) while the openings 30 are continuously open. Similarly, the openings 30 may be sufficiently small to prevent excessive cooling of the insulated area 5 (e.g., slightly larger than the cross-section of the largest product and/or the user's hand, as detailed above). In some embodiments, the openings 30 may create a temperature differential from 35° F. to 45° F. or any increment, subdivision, or individual temperature therein between the refrigerated area and the insulated area.

In some embodiments, a roller assembly 60 including a plurality of rollers or other conveying mechanisms (e.g., conveyors, dollies, carts, wheel assemblies, etc.) may be positioned adjacent the barrier 15 in the insulated area 5. As detailed below, the roller assembly 60 may allow one or more containers 17 to be quickly moved down the pick line for packaging.

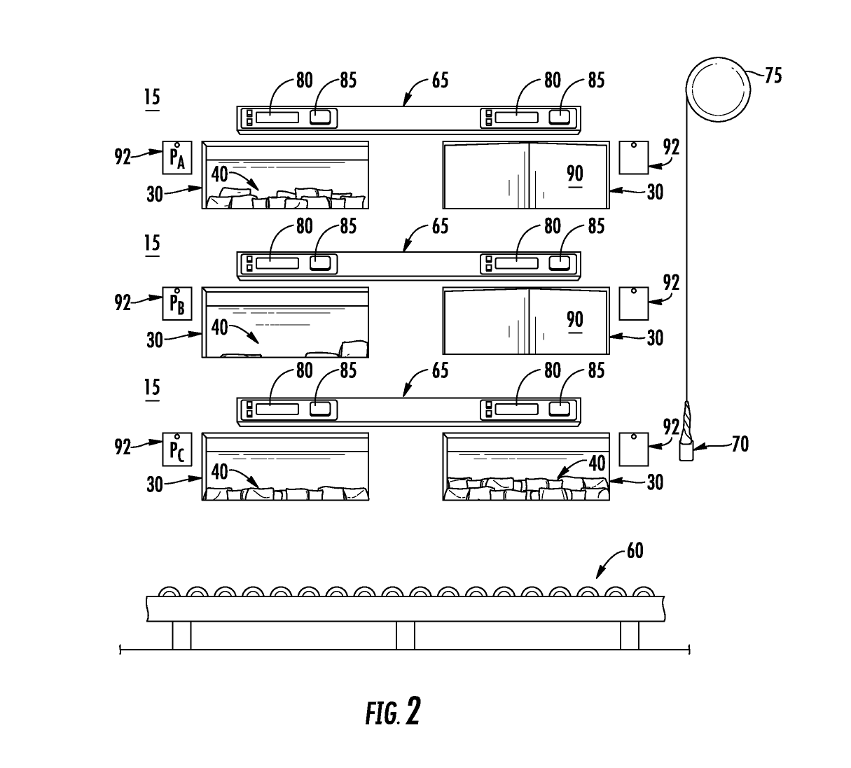

With reference to FIGS. 1-2, an order picking apparatus 65 may be used to indicate which of the products should be picked to fill a respective order for packaging. For example, in some embodiments, the order picking apparatus 65 may include a pick-to-light system. In a pick-to-light system, the user 1 may scan a code (e.g., a bar code or QR code) on a package (e.g., container 17) or an order form with a bar code scanner 70, which may be disposed at or, proximate the openings 30 via a retractable reel 75. The code may tell the pick-to-light system which order is currently being filled. For the current order, the pick-to-light system may display or otherwise indicate (such as via a displayed number or the lighting of an LED indicator) the quantity of each product needed to fill the order. For example, one or more displays 80 may be positioned adjacent each type of product 40, and/or, in some instances, adjacent each opening 30 to indicate the quantity of the product accessible through the respective opening that the user must pick. The displays 80 may be above, below, or to either side of the respective products 40 and/or openings 30. Once the required quantity of a given product 40 has been picked, the user 1 may indicate (e.g., by pressing button 85) that the pick has been made and that the product has been packed in the container. Other types of order picking apparatus may be used in addition to or instead of a pick-to-light system including, but not limited to, printed order lists, hand-held picking computers, workstation computer monitors, etc.

For example, in an order requiring three of Product P_{A}, two of Product P_{B}, and one of Product P_{C}, the user may scan the order into the order picking apparatus 65. The order picking apparatus 65 may then display, or otherwise indicate (e.g., on the screen 80 adjacent the respective opening 30 through which the respective product 40 may be accessed), the desired quantities of each product to the user. The user may then pick three of Product P_{A}, indicate that the first pick has been made, pick two of Product P_{B}, indicate that the second pick has been made, and pick one of Product P_{C}, and indicate that the third pick has been made. Each pick may be indicated by pressing a respective button 85 adjacent the opening 30 through which the picked product may be accessed. In each instance, the user may place the picked products into the container 17 for the respective order, which may then be sealed and sent to its destination.

With continued reference to FIG. 2, a front view of the pick line assembly system is shown from the user's perspective (e.g., the user standing in the insulated area 5 shown in FIG. 1). As detailed above, each of a plurality of openings 30 may be defined in the barrier 15 to allow the user to access the products 40 in each of the respective bins (e.g., bins 35 shown in FIG. 1). The barrier 15 may include one or more insulating materials to maintain a temperature difference between the refrigerated area (e.g., refrigerated area 10 shown in FIG. 1) and the insulated area (e.g., insulated area 5 shown in FIG. 1). In some embodiments, the barrier may be a building wall, such as an aluminum, drywall, wood, concrete, or other wall material, which may or may not include additional insulation (e.g., foam, fiberglass, etc.). In some embodiments, the barrier may be made of an insulating sheet, such as an expanded polystyrene foam (e.g., Styrofoam® manufactured by The Dow Chemical Company), rubberized foam, or other insulating material.

In some embodiments, the barrier 15 may be swappable or removable, which may allow different types and groupings of products to be rotated in the pick line without substantially reconstructing the system. For example, the barrier 15 may include a plurality of panels of polystyrene foam with various openings 30 defined therein. To facilitate a different number or configuration of openings, individual foam panels (e.g., including two, three, or all six openings, for example, as shown in FIG. 2) may be replaced with differently configured panels. The removable panels may span from floor to ceiling in the insulated area or a subsection thereof. In such embodiments, any number and placement of openings may be configured based on the size and position of the bins, the size and quantity of the products, and/or the number of users accessing each bin. Alternatively, the entire barrier 15 may be a single, replaceable section.

Additionally or alternatively, covers 90 may be disposed at one or more of the openings 30 to prevent airflow between the refrigerated area (e.g., the refrigerated area 10 shown in FIG. 1) and the insulated area (e.g., the insulated area 5 shown in FIG. 1). The covers may be used instead of or in addition to replacing the barrier 15 panels to reconfigure the openings 30. For example, if one or more bins do not include any products, if one or more products are not needed for a predetermined picking time period, or one or more users do not need to access one or more bins, one or more of the openings corresponding to these unneeded bins and/or products may be covered by a cover 90. Alternatively, one or more of the openings 30 may be continuously covered by a cover 90 and may be moved or removed by a user when picking products through the respective openings.

In some embodiments, the cover 90 may include an insert made of a cardboard, plastic, foam, or other material. The insert may be disposed in one of the openings 30 for restricting airflow therethrough to increase the insulation of the barrier 15 (e.g., to avoid loss of heat through the opening). Additionally or alternatively, the cover may be attached to the barrier 15, e.g., via a hinge, pivot point, strap, elastic band, or other retaining mechanism. In some embodiments, the cover may be pivotally mounted to the barrier 15 (e.g., as a flap) to allow the user to deflect the cover and pick the products. The cover 90 may, in such cases, be configured to move back in place once the user withdraws his or her hand.

As detailed above, the plurality of openings 30 may be defined in a number of configurations based on the picking process and the relative frequency of each product type in the orders. For example, FIG. 2 represents a view of the openings 30 from the insulated area (e.g., the insulated area 5 shown in FIG. 1) as seen by a user. The container (e.g., container 17 shown in FIG. 1) may be positioned on the roller assembly 60 adjacent the barrier 15 for assembly. Products having a higher relative frequency in orders may be positioned lower with respect to the barrier 15 (e.g., closer to the container), while products having a lower relative frequency in orders may be positioned higher with respect to the barrier. The openings 30 may be spaced horizontally and/or vertically from one another, and may correspond to the arrangement of bins in the refrigerated area (e.g., the refrigerated area 10 shown in FIG. 1). The barrier 15 may include one, two, or more columns of openings 30. In some embodiments, the openings 30 may be positioned such that each opening may be reached by the user with little to no steps required.

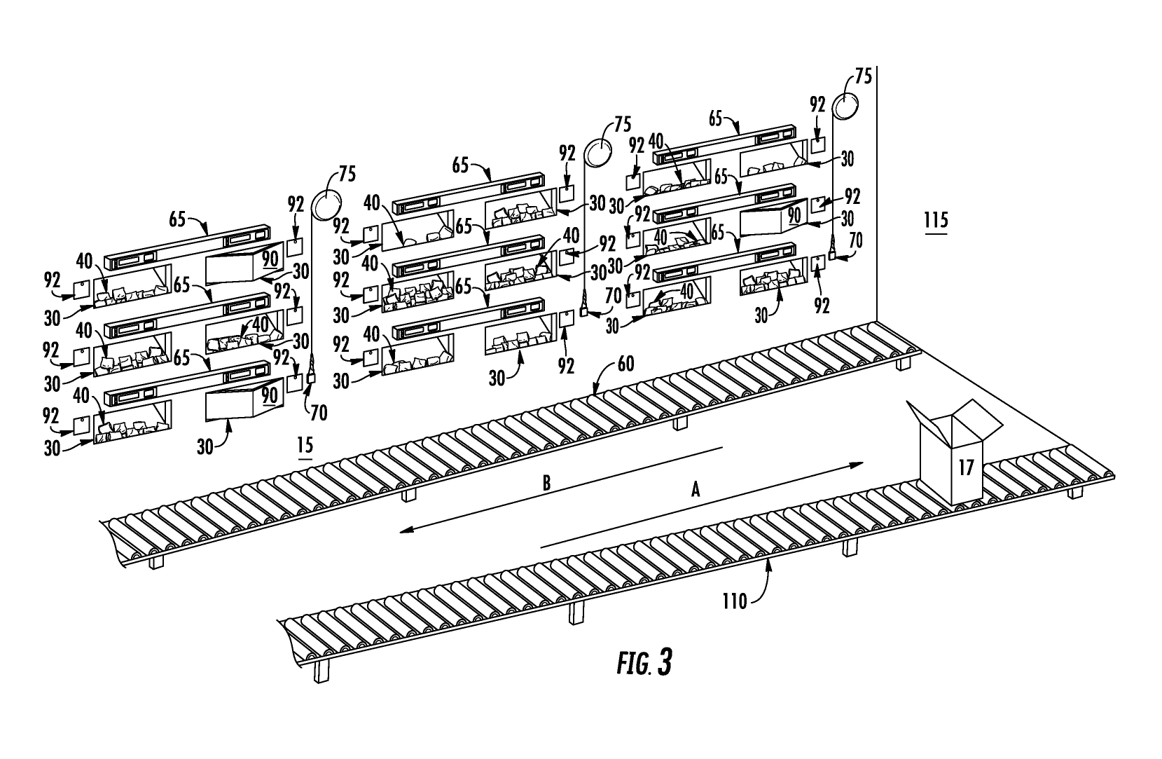

In some embodiments, with reference to FIG. 3, multiple zones 95, 100, 105 (e.g., workstations) of openings 30 may be defined in the barrier 15. Each zone 95, 100, 105 may include the same configuration (e.g., arrangement of openings and/or products) as the other, or different configurations from one another (e.g., in any of the configurations detailed herein with respect to a single group of openings, such as shown in FIG. 2). For example, in some embodiments, packages may be assembled in parallel, such that each zone 95, 100, 105 includes substantially the same products as the other zones. Alternatively, one or more zones 95, 100, 105 may include at least one different product than another zone. Further, in some embodiments, each product in one or more of the zones 95, 100, 105 may be different from each product in another zone. For example, in some embodiments, packages may be assembled in series from two or more of the zones 95, 100, 105. In some embodiments, the same product may be positioned in different respective locations (e.g., adjacent a different opening relative to the other openings of its zone) in two different zones 95, 100, 105.

Additionally or alternatively, different zones 95, 100, 105 may include different arrangements of products, openings, and/or bins, such that any number and configuration of products, openings, and/or bins may be used in each respective zone. For example, a first zone may have six openings (e.g., arranged as shown in FIGS. 2-3), while a second zone may include four openings. Still another zone may include six openings arranged as three columns and two rows. As detailed above, one bin may be positioned in front of multiple openings (e.g., for popular items or items for which multiple workers must access the same bin). In such embodiments, a single bin may span multiple zones and/or a single bin may span multiple vertically arranged or horizontally arranged openings in a single zone. In such embodiments, some of the multiple openings may be covered (e.g., with a cover 90) and/or unused by one user while other openings are accessed by another user, or the openings may be accessed simultaneously.

Similarly, in some embodiments, multiple bins may be arranged adjacent a single opening. For example, if multiple components are required for a single “product,” each of the components may be arranged adjacent the same opening and may use the same order picking apparatus 65. Alternatively, for items that are infrequently used, or are sold in small quantities, picking area may be conserved by allocating two products with a lower sale rate for access via a single opening (e.g., stocking the same bin with smaller quantities of each, or by subdividing a bin for receiving a portion of each product).

In some embodiments, as discussed above, zones 95, 100, 105 may be grouped such that each zone is accessible to a subset of the users (e.g., one user, two users, or a greater number of users) with minimal to no lower-body movement. For example, with continued reference to FIGS. 2-3, the zones may include three groups of vertically-spaced openings 30 (e.g., vertically-spaced rows) and two groups of horizontally-spaced openings (e.g., horizontally-spaced columns). Each of the horizontally spaced openings may share a common order picking apparatus, or multiple order picking apparatus may be positioned on the same assembly (e.g., as shown in FIGS. 2-3), with one or more displays 80 corresponding to each respective opening. For example, each opening 30 in a zone 95, 100, 105 may be arranged between four and six feet away from the user's torso to allow the user to reach the respective openings from the same standing position. In some embodiments, the openings 30 may be spaced to align with one or more standard bin configurations. In some embodiments, the openings 30 in one zone 95, 100, 105 may be positioned closer to one another than to openings 30 in a second zone 95, 100, 105.

With continued reference to FIG. 3, an example layout of the insulated area is shown. The roller assembly 60 may be positioned adjacent to the barrier 15, including the zones 95, 100, 105 of openings 30, such that the roller assembly 60 runs parallel to the barrier 15 (e.g., such that containers 17 can travel parallel to the barrier 15). This configuration may allow containers 17 to receive products from one or more zones 95, 100, 105 without being manually carried by a user between the respective zones.

In some embodiments, a second roller 110, which may include rollers, conveyors, dollies, carts, wheel assemblies, etc., may be disposed adjacent an opposite wall (not shown) from the barrier 15 to deliver empty containers 17 to a terminal end 115 of the insulated area. An example workflow is shown in the respective arrows A, B in FIG. 3, wherein an empty container 17 may be provided in a first direction A towards the terminal end 115 of the insulated area. A user may retrieve the container 17 and proceed in a second direction B along the roller assembly 60 adjacent the barrier 15 to pick the necessary products 40.

In embodiments in which each container 17 does not travel to each zone 95, 100, 105, a user may retrieve the container at any point along the second roller assembly 110. In some embodiments, a single user or group of users at the terminal end 115 may retrieve the containers 17 at the terminal end and begin the pick assembly at the terminal end (e.g., zone 105 in the embodiment shown in FIG. 3). In some embodiments, the second roller assembly 110 may be inclined downwardly towards the terminal end 115 to encourage travel of the empty containers 17.

Alternatively, in some embodiments, empty containers 17 may be introduced to the insulated area at a first end of the barrier 15 (e.g., proximate zone 95 in FIG. 3) and may travel along the barrier via the roller assembly 60 towards a second end of the barrier (e.g., proximate zone 105 in FIG. 3). At the second end of the barrier, the containers may be returned to the first end (e.g., via an oppositely inclined second roller) or may continue in the same direction towards a loading dock, storage area, or other final area of the picking process proximate the second end (e.g., in cases where there is no terminal end 115).

In some alternative embodiments, the barrier may include a plurality of parallel wall segments on opposite sides of the insulated area each having a plurality of openings, such that multiple containers may be loaded in parallel or series, in the same or opposite directions along two wall sections of the barrier 15 adjacent the refrigerated area. For example, in such embodiments, the insulated area may define a tunnel through a center of the refrigerated area, such that bins may be lined up along multiple walls of the barrier. In some alternative embodiments, the external wall of the refrigerated area may define at least one bounding wall of the insulated area 5 (e.g., abutting a ceiling 25 of the barrier shown in FIGS. 1, 4), such that the surface area of the barrier 15 may be minimized. In some further embodiments, more than two walls may include openings for picking products during the assembly process.

With reference to FIG. 4, an insulated area 5 as detailed herein is shown in a refrigerated area 10. As detailed herein, the insulated area may define a tunnel or smaller room within a refrigerated warehouse, such that the insulated area may be bordered by the refrigerated area on two or more sides. In such embodiments, the insulated area 5 may be assembled by separating a subsection of the refrigerated area 10 from the remainder of the refrigerated area with a barrier. In some embodiments, the insulated area 5 may be positioned in communication with one or more large loading doors to allow assembled packages (e.g., containers 17) to be taken directly into a processing area and/or a loading dock for shipping. Alternatively, as discussed above, the insulated area may be bordered by the refrigerated area on one side.

With continued reference to FIG. 4, a second user 2 or a robotic equivalent (e.g., autonomous or user-controlled stocking machines) may replenish the bins 35 with additional and/or different products 40. The second user 2 may replenish the bins 35 individually when a bin reaches a minimum threshold quantity of products 40.

The refrigerated area 10 may include bulk storage for holding pallets, boxes, or the like (e.g., boxes 120 shown in FIG. 4) containing products for storage prior to being placed in the bins. As shown in FIG. 4, the second user 2 may retrieve the boxes 120 for stocking the bins 35. The boxes 120 may be positioned on a third roller assembly 125 similar to the roller assembly 60 for transporting the boxes to a respective bin 35. The second user 2 may resupply the respective bins 35 in large quantities from boxes 120 containing at least one type of product each. In this manner, products 40 may be unpacked from their original boxes 120 and roughly sorted into the bins for the first user 1 to retrieve to increase the picking efficiency of the users in the insulated area 5 as detailed above. Each bin may include electronic or physical labels or other indicia (e.g., labels 92) to display which products 40 correspond to which bins 35, and the indicia may be visible from the refrigerated area 10 and/or the insulated area 5. For example, these labels may be used in case of a power failure or data corruption in the order picking apparatus 65.

With reference to FIG. 5, a rear view of the pick line assembly system is shown from the second user's perspective in the refrigerated area (e.g., from the refrigerated area 10 shown in FIGS. 1, 4). The refrigerated area 10 may include the bins 35 supported by scaffolding 130 or other framework structure. Additionally or alternatively, as detailed above, the bins may be stationary racks, shelves, containers, stalls or the like, and in some alternative embodiments the bins may be movable storage devices such as pallets, boxes, crates, rolling shelves, or other containers that may, themselves, be moved into position against the barrier 15 for packaging.

In the embodiment shown in FIG. 5, the bins 35 in the refrigerated area 10 may define shelves 45 for receiving the products 40. The bins 35 may further include vertical dividers 135 for laterally maintaining the products 40 within the bins 35. The bins 35 may be adjacent one another vertically and/or horizontally. Additionally or alternatively, the bins 35 may be spaced from one another vertically and/or horizontally. For example, the bins 35 may be horizontally spaced from bins on opposite sides of the scaffolding 130. Similarly, the bins 35 may be vertically spaced. In embodiments in which the bins are vertically disposed with respect to one another (e.g., vertically adjacent or vertically spaced), the dividers 135 may span the bins 35. In some embodiments, the bins may be vertically separate units stacked atop one another or connected to vertically separate locations on the scaffolding 130.

In some embodiments, one or more bins 35 may be arranged horizontally between respective scaffolding 130 sections. For example, as shown in FIG. 5, two adjacent bins 35 are disposed in each row between the scaffolding 130. Bins may be horizontally distinct, such that they may be individually removed or added, or alternatively, as shown in FIG. 5, two or more horizontally adjacent bins 35 may share a common divider 135 and/or common shelf 45.

In some embodiments, a lateral support 140 may be disposed at the top of each bin 35 to provide additional support. In some embodiments, the lateral support 140 may include the shelf 45 of the bin directly above the laterally supported bin. Additionally or alternatively, the lateral support 140 may include a beam or other structural member.

In some embodiments, the scaffolding 130 and bins 35 may be expandable, such that additional bins may be added above, below, or to either side of the existing bins. As detailed above, corresponding openings 30 may then be positioned adjacent the new bins in the barrier 15.

As detailed above, the openings 30 may be positioned in any desired configuration to facilitate access to the bins 35. As shown in FIG. 5, the bins 35 may define a larger cross-sectional area than the openings 30. In some embodiments, the zones (e.g., zones 95, 100, 105 shown in FIG. 3) may be spaced horizontally such that additional bin space is available. In some embodiments, the bins 35 may each define a horizontal dimension (e.g., left and right with respect to the orientation of FIG. 5) that is larger than a respective vertical dimension (e.g., up and down with respect to the orientation of FIG. 5).

The bins 35 may define a depth (e.g., into and out of the page with respect to the orientation of FIG. 5). In some embodiments, the depth of the bins 35 may be sufficiently small to allow the user to reach the rear of the bin (e.g., less than an arm's length of the user). In some alternative embodiments, for example in embodiments with a shelf 45 that is sloped downwardly towards the openings 30, the depth of the bins 35 may be greater than an arm's length of the user. In such embodiments having a sloped shelf 45, the rear portions of the bin 35 farthest from the opening may hold additional products 40 that travel towards the opening 30 as products are removed from the opening by the user 1 in the insulated area 5 (e.g., as shown in FIG. 4) in a first-in-first-out (FIFO) configuration.

In some embodiments, a method of manufacturing a pick line assembly system may be provided. The method may include providing a plurality of bins (e.g., bins 35 shown in FIGS. 1, 4-5) in a refrigerated area (e.g., refrigerated area 10 shown in FIGS. 1, 4). Each bin (e.g., bins 35 shown in FIGS. 1, 4-5) may be configured to receive at least one product (e.g., products 40 shown in FIGS. 1-5) for picking. The method may further include installing a barrier (e.g., barrier 15 shown in FIGS. 1-5) separating the refrigerated area (e.g., refrigerated area 10 shown in FIGS. 1, 4) from an insulated assembly area (e.g., insulated area 5 shown in FIGS. 1-4). In some embodiments, the insulated assembly area (e.g., insulated area 5 shown in FIGS. 1-4) may be configured to be warmer than the refrigerated area (e.g., refrigerated area 10 shown in FIGS. 1, 4). In some embodiments, the barrier (e.g., barrier 15 shown in FIGS. 1-5) defines at least one opening (e.g., the openings 30 shown in FIGS. 1-5), such that the refrigerated area (e.g., refrigerated area 10 shown in FIGS. 1, 4) is connected to the insulated assembly area (e.g., insulated area 5 shown in FIGS. 1-4) via the at least one opening (e.g., the openings 30 shown in FIGS. 1-5). In some embodiments, the plurality of bins (e.g., bins 35 shown in FIGS. 1, 4-5) are disposed adjacent the barrier (e.g., barrier 15 shown in FIGS. 1-5), such that each bin is accessible from the insulated assembly area (e.g., insulated area 5 shown in FIGS. 1-4) via the at least one opening (e.g., the openings 30 shown in FIGS. 1-5).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. For example, in some alternative embodiments, the refrigerated area may instead be reconfigured as a heated area, such that the insulated area defines a cooler temperature than the heated area, and in either embodiment, the insulated area defines a more moderate temperature (e.g. closer to room temperature of approximately 70° F.). Further, although users may be referred to as humans herein, the users may include any computerized or robotic pick line assembly system components that sort and assemble products into packages for shipping. While some drawings and description may omit features described elsewhere for simplicity of explanation, it is understood that these features may nonetheless be present in any of the embodiments in any combination or configuration, as detailed above. Although specific terms are employed herein, they are used in a generic and descriptive sense only and not for purposes of limitation.

1. An insulated pick line assembly system for refrigerated goods, the pick line assembly system comprising:
a refrigerated area comprising a plurality of bins, wherein each bin is configured to receive at least one product for picking;
an insulated assembly area separated from the refrigerated area by a barrier;
wherein the insulated assembly area is configured to be warmer than the refrigerated area,
wherein the barrier defines at least one opening, such that the refrigerated area is connected to the insulated assembly area via the at least one opening, and
wherein the plurality of bins are disposed adjacent the barrier, such that each bin is accessible from the insulated assembly area via the at least one opening.

2. The pick line assembly system of claim 1, wherein the barrier defines at least one wall and at least one ceiling, and wherein the insulated assembly area is disposed at least partially below the at least one ceiling.

3. The pick line assembly system of claim 1, wherein the barrier is disposed within a refrigerated warehouse.

4. The pick line assembly system of claim 1, wherein the at least one opening comprises a plurality of openings, and wherein each bin is disposed adjacent to at least one of the plurality of openings.

5. The pick line assembly system of claim 4, wherein the plurality of openings comprise a first zone comprising a first plurality of openings and a second zone comprising a second plurality of openings, wherein each opening of the first plurality of openings are closer to at least one other opening of the first plurality of openings than to any opening of the second plurality of openings.

6. The pick line assembly system of claim 5, further comprising a code scanner proximate at least one of the first zone or the second zone.

7. The pick line assembly system of claim 4, wherein at least two of the plurality of openings are spaced vertically from each other.

8. The pick line assembly system of claim 4, wherein at least two of the plurality of openings are spaced horizontally from each other.

9. The pick line assembly system of claim 4, further comprising a cover configured to substantially close at least one of the plurality of openings.

10. The pick line assembly system of claim 9, wherein the cover is movably attached to the barrier.

11. The pick line assembly system of claim 9, wherein the cover is removably positioned in the at least one of the plurality of openings.

12. The pick line assembly system of claim 1, further comprising an order picking apparatus disposed adjacent each bin.

13. The pick line assembly system of claim 1, further comprising a roller assembly adjacent the barrier in the insulated assembly area, wherein the roller assembly defines a longitudinal direction disposed parallel to the barrier.

14. The pick line assembly system of claim 1, wherein the insulated assembly area defines at least one terminal end terminating at a side wall and at least one open end,
wherein the barrier extends between the at least one terminal end and the at least one open end,
wherein the pick line assembly system further comprises an inclined roller assembly in the insulated assembly area, and
wherein the inclined roller assembly declines from the open end to the terminal end, such that the inclined roller assembly is configured to deliver boxes to the at least one terminal end.

15. A method for manufacturing a pick line assembly system, the method comprising:
installing a barrier separating a refrigerated area from an insulated area, wherein the refrigerated area comprises a plurality of bins, and wherein each bin is configured to receive at least one product for picking;
wherein the insulated assembly area is configured to be warmer than the refrigerated area,
wherein the barrier defines at least one opening, such that the refrigerated area is accessible from the insulated assembly area via the at least one opening, and
wherein the plurality of bins are disposed adjacent the barrier, such that each bin is accessible from the insulated assembly area via the at least one opening.

16. The method of claim 15, wherein installing the barrier comprises installing the barrier in a refrigerated warehouse.

17. The method of claim 16, further comprising disposing a cover in or over at least one of the plurality of openings, such that the cover is configured to substantially close the at least one of the plurality of openings.

18. The method of claim 15, further comprising attaching an order picking apparatus adjacent each bin.

19. The method of claim 15, further comprising positioning a roller assembly adjacent the barrier in the insulated assembly area, wherein the roller assembly defines a longitudinal direction disposed parallel to the barrier.

20. The method of claim 15, wherein the insulated assembly area defines at least one terminal end terminating at a side wall and at least one open end,
wherein the barrier extends between the at least one terminal end and the at least one open end,
wherein the method further comprises positioning an inclined roller assembly in the insulated assembly area, and
wherein the inclined roller assembly declines from the open end to the terminal end, such that the inclined roller assembly is configured to deliver boxes to the at least one terminal end.
